(19) United States
(12) Patent Application Publication
(10) Pub. No.: US 2006/0015670 A1
(43) Pub. Date: Jan. 19, 2006

(54) Apparatus for detecting connection of a peripheral unit to a host system

(75) Inventors: Kalman Cinkler, Munich (DE); Till Winteler, Munich (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/169,157

(22) Filed: Jun. 27, 2005

(30) Foreign Application Priority Data
Jun. 28, 2004 (DE) 10 2004 031 278.8

(51) Int. Cl. G06F 13/00

(52) U.S. Cl. 710/302

(57) ABSTRACT

An apparatus and method for detecting a connection of a peripheral unit to a host system via a data transmission interface, wherein the host system includes at least one switching device which sets a connection between at least one data line of the data transmission interface and a prescribed potential in the host system.

### CROSS-REFERENCE TO RELATED APPLICATION

This application claims priority to German Patent Application Ser. No. 10 2004 031 278.8, filed Jun. 28, 2004, and which is incorporated herein by reference in its entirety.

### FIELD OF THE INVENTION

The invention relates to an apparatus for detecting the connection of at least one peripheral unit to a host system via a data transmission interface, and a method for operating such an apparatus.

### BACKGROUND OF THE INVENTION

The problem of connecting peripheral units to a host system is solved particularly elegantly by the universal serial bus (USB). Very close coordination of the physical, electrical and logic elements of this connection system allows a multiplicity of different peripheral units to be connected to a host. One particular feature of the USB bus is that USB units can be connected to the host (“hot plugging”) or disconnected from the host (“sudden removal”) during operation. This property allows peripheral units to be connected to and disconnected from the host again in very simple fashion without the need for further action by the user. The simple handling is certainly a fundamental reason for the widespread use of the USB bus.

FIG. 1 shows a USB host 1 which is connected to a peripheral unit 2 via a data transmission interface 3. In this case, the system is configured for the high-speed mode. The USB data transmission interface 3 comprises four lines: the supply potential Vbus, the ground potential GND and the data lines D+, D−. In the host 1, the data lines D+ and D− are connected to the ground potential GND via respective pull-down resistors Rpd. In the peripheral unit 2, the data line D+ is connected to the supply voltage Vbus via a pull-up resistor Rpu. For the sake of completeness, FIG. 1 also shows bus drivers, buffers and logic elements for actuating the data lines D+ and D− in the host 1 and in the peripheral unit 2, the operation of these components not being described further here.

The connection of a peripheral unit 2 to the host 1 is signaled in the USB bus by the signal level of the data lines D+ and D−. If no peripheral unit 2 is connected, the data lines D+ and D− are pulled to the ground potential GND via the pull-down resistors Rpd in the host 1. If a peripheral unit 2 is now connected to the host system 1 via the data transmission interface 3, the data line D+ in FIG. 1 is pulled to the supply potential Vbus via the pull-up resistor Rpu in the peripheral unit 2. The voltage divider comprising the pull-up resistor Rpu and the pull-down resistor Rpd is proportioned such that the data line D+ is always pulled to the supply potential Vbus, despite the pull-down resistor Rpd. If the peripheral unit 2 is disconnected from the host 1, the data line D+ is no longer pulled to the supply potential Vbus by the pull-up resistor Rpu but rather is pulled to the ground potential GND by the pull-down resistor Rpd. The change in the potential in the data line D+ thus makes it possible to detect, in the host 1, when a peripheral unit 2 is connected to and disconnected from the host 1.

FIG. 2 shows a USB connection system in which a peripheral unit 2 is connected to the host 1 in the low-speed mode. Unlike in FIG. 1, it is now no longer the data line D+ which is pulled to the supply potential Vbus via the pull-up resistor Rpu, but rather the data line D−. In a similar way to in FIG. 1, the potential of the data line D− can be used to identify connection of a peripheral unit 2 to a host 1. The data transmission speed in the USB bus (high speed or low speed) is stipulated by virtue of either the data line D+ or the data line D− being connected to the supply potential Vbus via a pull-up resistor Rpu in the peripheral unit 2. In the high-speed mode shown in FIG. 1, it is the data line D+, and in the low-speed mode shown in FIG. 2, it is the data line D−. The pull-up resistors Rpu in the peripheral unit 2 are thus used not only to detect connection of a peripheral unit 2 to the host 1, but also to signal the speed of the data transmission.

As soon as a peripheral unit 2 is connected to the host 1, a current Ibias flows to the ground potential GND from the supply potential Vbus via the pull-up resistor Rpu, the data line D+ and the pull-down resistor Rpd. This flow of current is shown in FIG. 1 by the arrow Ibias. A similar situation applies to the low-speed mode shown in FIG. 2, where the current Ibias flows not via the data line D+ but rather via the data line D−. This constantly flowing bias current Ibias makes it possible to identify when a peripheral unit 2 is connected to and disconnected from the host 1.

The bias current is calculated from Ibias=Vbus/(Rpu+Rpd). When Rpu=1.5 kΩ and Rpd=15 kΩ, a supply potential of Vbus=3.3 V makes the bias current Ibias=200 μA, and Vbus=5 V makes Ibias=303 μA. This current Ibias continues to flow for as long as a peripheral unit 2 is connected to the host 1. If the flow of current in the case of fixed-location applications, such as a PC, is negligible, then the constant power requirement in the case of mobile, generally battery-operated applications, such as a mobile phone with a USB-SIM card, is a significant restriction.

### SUMMARY OF THE INVENTION

The invention is therefore based on an object of specifying an apparatus which can be used to reduce the bias current and of specifying a method for operating such an apparatus.

The invention achieves this object by virtue of the host system containing at least one switching device for the purpose of setting up a connection between at least one of the data lines of the data transmission interface and a prescribed potential in the host system.

### BRIEF DESCRIPTION OF THE DRAWINGS

The invention is explained in more detail below using exemplary embodiments with reference to the drawings, in which:

FIG. 1 shows a USB connection system in full-speed mode based on the prior art;

FIG. 2 shows a USB connection system in low-speed mode based on the prior art;

FIG. 3 shows a USB connection system with a switching device for full-speed data transmission;

FIG. 4 shows a USB connection system with a switching device for low-speed data transmission;

FIGS. 5a, b, and c show exemplary embodiments of the switching device;

FIG. 6 shows a switching device with a cycle generator; and

FIG. 7 shows an exemplary embodiment of a USB connection system with switching devices for both low-speed and full-speed data transmission.

### DETAILED DESCRIPTION OF PREFERRED EMBODIMENTS OF THE INVENTION

An apparatus for detecting a connection of at least one peripheral unit to a host system via a data transmission interface in which the host system has at least one switching device for the purpose of setting up a connection between at least one of the data lines of the data transmission interface and a prescribed potential in the host system.

The fact that the data lines in the data transmission interface are now no longer permanently connected to a prescribed potential in the host but rather can be connected selectively results in a series of advantages. If the data lines of the data transmission interface are disconnected from the prescribed potential in the host system by the switching device, then a bias current cannot flow. This is of particular advantage in mobile, battery-operated applications, which are therefore given a longer operating time.

If no bias current is flowing, then it is no longer possible to identify whether or not a peripheral unit is connected to the host. This is not necessarily a significant drawback, however, since in some applications it is not actually possible to disconnect the peripheral unit from the host system without turning off the entire system beforehand. A USB-SIM card may be removed, by way of example, only if the mobile telephone is opened and the battery is taken out, which automatically turns off the entire system. “Sudden removal” or “hot plugging” of the peripheral unit is not possible in these cases and therefore also does not need to be detected.

If it is necessary to detect when a peripheral unit is connected to or disconnected from the host system, the switching device can be used to connect at least one of the data lines of the data transmission interface to a prescribed potential in the host system. The selective connection means that it is still possible to identify connection of a peripheral unit to the host without this always requiring the flow of a bias current.

In line with one development, the switching device comprises a resistor in series with a switch. In this arrangement, the resistor is used to pull the data line to a prescribed potential via the switch. In this case, the simplicity of the arrangement is advantageous.

Advantageously, the series circuit comprising the resistor and the switch has a further resistor connected in parallel with it. In this way, it is possible to prevent the data line from having an undefined potential when the switch is open and a peripheral unit is not connected.

In another embodiment, a resistor is connected not in parallel with the series circuit comprising the first resistor and the switch, but rather solely in parallel with the switch. This also allows the potential of the data line to be fixed at a particular value when the switch is open and a peripheral unit is not connected. In this case, it is advantageous that the resistor for this switching device is obtained essentially from the resistance of the first resistor when the switch is closed.

In one development, the prescribed potential in the host system to which the data lines are connected via a switching device is the ground potential. This means that a data transmission interface having just four lines is sufficient.

In one advantageous development, the switching device for connecting at least one of the data lines of the data transmission interface to a prescribed potential in the host system is connected to a cycle generator. The cycle generator can periodically close and open a switch in the switching device. In this way, a bias current flows only at the times at which the switch in the switching device is closed. In this case, the period of the cycle generator can be chosen to be short enough for it to be possible to detect when a peripheral unit is connected to or removed from the host system in timely fashion or else can be chosen to be long enough for the current drawn over a relatively long period to be minimal.

In one development, the data transmission interface has two data lines, a current supply line and a ground line. In this way, the invention can be applied to data transmission interfaces which comprise such lines, such as the USB bus.

Advantageously, the data lines are connected to the ground line in the host system via switching devices, and to the voltage supply line in the peripheral unit via further switches and via at least one resistor. In this way, the data transmission rate can be determined by the peripheral unit, and additionally the connection of a peripheral unit can be detected.

Advantageously, the data transmission interface corresponds to the universal serial bus USB 2.0 specifications when the connections of the switching devices in the host system are connected. The effect achieved by this is that full compatibility with this standard is ensured, and existing USB units can be connected to host units which have the invention.

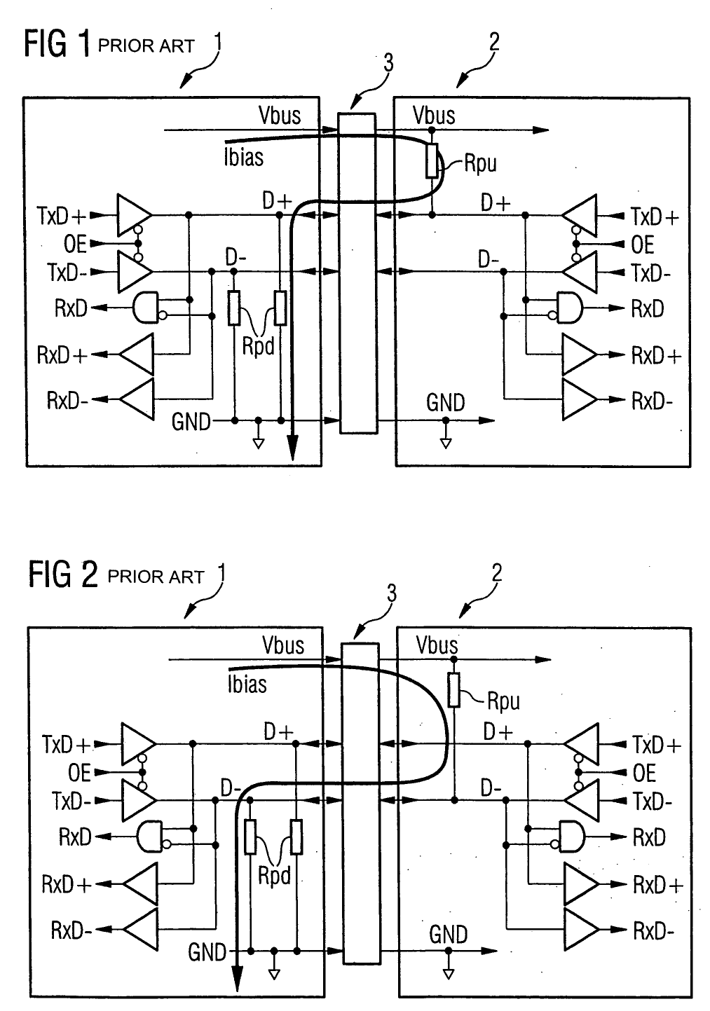

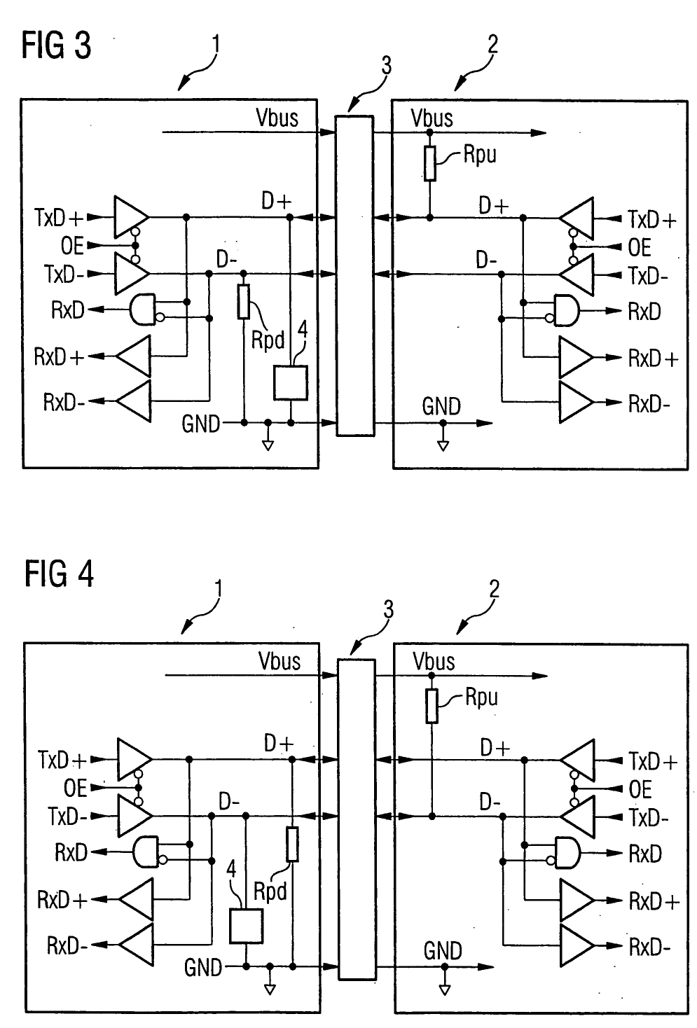

FIG. 3 shows an exemplary embodiment of a connection system comprising a host 1 with a peripheral unit 2 connected to it via a data transmission interface 3. FIG. 3 differs from FIG. 1 in that the data line D+ is now not permanently connected to the ground potential GND in the host system by means of a pull-down resistor Rpd, as in FIG. 1, but rather by a switching device 4. The switching device 4 allows the data line D+ to be selectively connected to the ground potential GND via a resistor.

When the switching device 4 is in the closed state, so that the data line D+ is connected to the ground potential GND, a current flows (driven by the supply potential Vbus) via the pull-up resistor Rpu in the peripheral unit 2, the data line D+ and the switching device 4 to the ground potential GND. The voltage level which then appears on the data line D+ makes it possible to detect when the peripheral unit 2 is connected to or removed from the host system 1 using an appropriate mechanism in the host system 1.

When the peripheral unit 2 is disconnected from the host system 1, the data line D+ is no longer pulled to the supply potential Vbus by the pull-up resistor Rpu in the peripheral unit 2, and this can be detected in the host system 1 and can be used to trigger appropriate actions. The closed state of the switching device 4 is therefore of particular interest when peripheral units 2 are connected to or disconnected from a host 1 afresh.

If it is not necessary to monitor constantly whether peripheral units 2 are connected to the host system 1, the switching device 4 can be switched to an open state. In this state, either no or just a very small current flows from the supply potential Vbus via the pull-up resistor Rpu in the peripheral unit 2, the data line D+ and the switching device 4 to ground potential GND. The very small current in comparison with the prior art is of particular interest for battery-operated applications or for applications in which it can be assumed that the peripheral unit 2 is not disconnected from the host system 1 for a relatively long period. This is the case, for example, with a USB keyboard, which, following successful connection and configuration, does not require “hot plugging” or “sudden removal” functionality, since it is disconnected from the PC only rarely.

Should such a situation nevertheless require a check to determine whether a peripheral unit 2 is connected to the host 1, this can be done at any time by closing the switching device 4. In this case, the switching device 4 may be designed such that in the closed state the full functionality of a USB bus is possible while observing all stipulations from the USB specification.

FIG. 4 shows an exemplary embodiment of a connection system for low-speed connections. In contrast to the full-speed connection shown in FIG. 3, it is now no longer the data line D+ which is connected to the supply potential Vbus via a pull-up resistor Rpu, but rather the data line D−. In addition, the data line D+ is now connected to the ground potential GND directly via a pull-down resistor Rpd, and the data line D− is connected to the ground potential GND via.the switching device 4. The way in which the connection system in FIG. 4 works corresponds to that described together with FIG. 3, except that the data lines D+ and D− are interchanged, and the connection system is therefore configured for low-speed data transmission instead of full-speed data transmission.

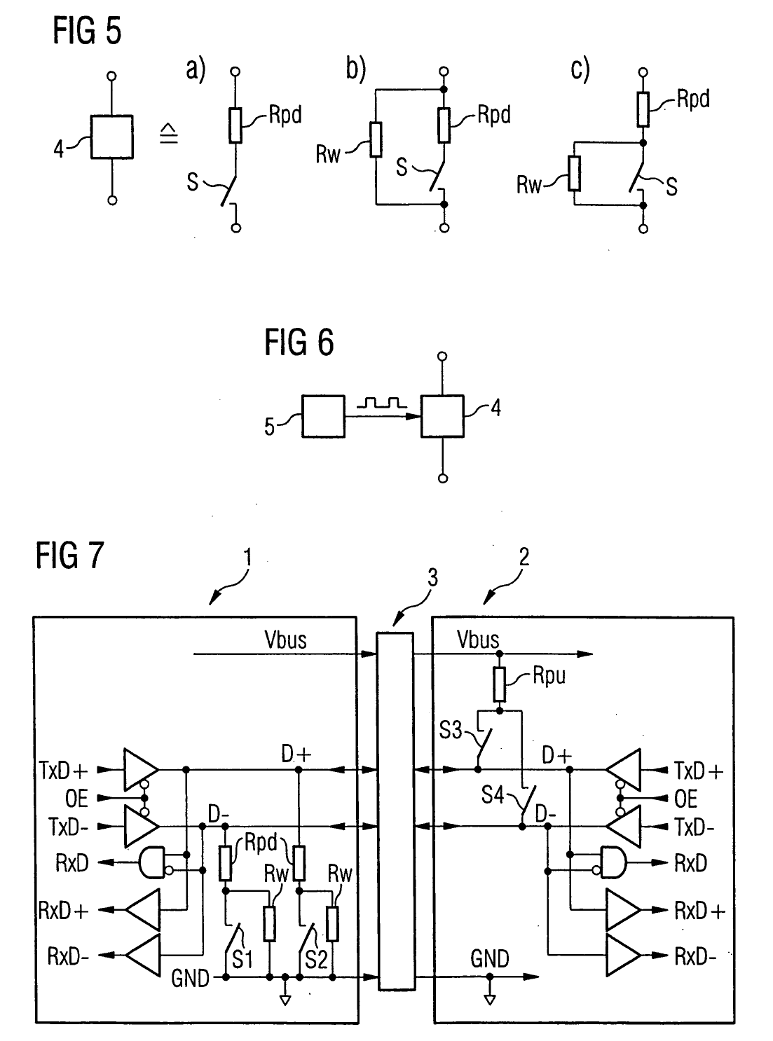

FIGS. 5a to 5c show exemplary embodiments of the switching devices 4. In the simplest case, the switching device 4 is implemented as shown in FIG. 5a. In this arrangement, a resistor Rpd is connected in series with a switch S. The resistor Rpd may be produced using any technology in this context, and advantageously has a value which corresponds to that in the USB 2.0 specification. All known switching mechanisms may be used for the switch S, and it is advantageously in the form of an electronic switch. A further variant involves the switch S and the resistor Rpd being combined in one component whose resistor can be controlled in appropriate fashion.

FIG. 5b shows a further embodiment of the switching device 4 in which the series circuit comprising the pull-down resistor Rpd and the switch S additionally has a resistor Rw connected in parallel with it. If the switching device 4 is implemented as shown in FIG. 5a, the data line D+ in FIG. 3 or the data line D− in FIG. 4 has an undefined potential when the switch S is open and the peripheral unit 2 is disconnected. Depending on the implementation, this may result in unwanted effects.

To prevent this, the data lines D+ and D− in the embodiment of the switching device 4 which is described in FIG. 5b are connected to the ground potential GND via a resistor Rw. In this case, the resistor Rw needs to have a much higher resistance than the pull-down resistor Rpd so that in this case an undesirably high bias current does not again flow to ground from the supply potential Vbus via the pull-down resistor Rpd, one of the data lines D+ or D− and Rw when a peripheral unit 2 is connected. If the switch S is closed, the parallel circuit comprising the resistors Rw and Rpd produces a resistance which corresponds essentially to Rpd. For the design of the resistors Rw and Rpd and of the switch S, the statements made in the description of FIG. 5a apply.

FIG. 5c shows a further embodiment of the switching device 4. The arrangement known from FIG. 5a is extended by a resistor Rw connected in parallel with the switch S. The functionality corresponds essentially to that of the arrangement described in FIG. 5b. If the switch S is open, the data line D+ or D− is connected to the ground potential GND and hence to a defined potential via the series circuit comprising the pull-down resistor Rpd and the resistor Rw. When the switch S is closed, the resistor Rw is bridged, which means that the data line D+ or D− is now connected to the ground potential GND via the pull-down resistor Rpd as in the USB specification.

FIG. 6 shows an arrangement in which the switching device 4 is actuated by a cycle generator S. The switching device 4 may in this case again correspond to one of the embodiments from FIG. 5a, 5b or 5c. The cycle generator 5 switches the switching device 4 periodically into the on or off state. This may be done by operating a switch S, for example. In this way, it is possible to check when a peripheral unit 2 is connected to and disconnected from the host system 1 at regular intervals of time. If the switching device 4 is turned on for 3 μs for every 1 ms, for example, it would be possible to detect when a peripheral unit 2 is connected to or disconnected from the host 1 within 1 ms. In this case, the time average for the bias current flowing through the switching device 4 is only 0.3% of the previous current Ibias=200 μA.

The periodic changeover of the switching device 4 means that the potential of the data line D+ or D− will also fluctuate periodically. To avoid interference with the data transmission, it is possible to choose the times at which the cycle generator 5 actuates the switching device 4 such that they occur at times at which the data transmission is not disrupted, such as during a synchronization interval. Instead of a cycle generator 5, the switching device 4 could also be actuated by other signals, for example sensors or a manual switch.

FIG. 7 shows an exemplary embodiment of a connection system comprising a host system 1, a peripheral unit 2 and a data transmission interface 3, which connection system is suitable for both low-speed and full-speed data transmissions. In this case, the switching device 4 is designed in accordance with FIG. 5c, but other embodiments are possible. The data transmission rate is stipulated by means of the switches S3 and S4 in the peripheral unit in this case.

For full-speed data transmission, the data line D+ is connected to the supply potential Vbus via the pull-up resistor Rpu. The switch S1 remains closed and connects the data line D− to the ground potential GND via the pull-down resistor Rpd. Since the switch S4 is open, a constant bias current does not flow via the data line D−. When the switch S2 is open, the data line D+ in the host system is likewise connected to the ground potential GND via the series circuit comprising the pull-down resistor Rpd and Rw. In this way, the data line D+ has a defined potential even when the peripheral unit 2 is disconnected. However, since Rw is again chosen to be large in relation to Rpd, only a small current flows. Rw could have values in the MΩ range and Rpd could have values in the kΩ range, for example.

To detect the presence of a peripheral unit 2, the switch S2 is closed. As a result, a current flows to the ground potential GND from the supply voltage Vbus via the pull-up resistor Rpu, the switch S3, the data line D+ and the pull-down resistor Rpd, which results in a change of level on the data line D+ if the peripheral unit 2 is connected, and this change of level can be evaluated in the host system 1.

For data transmission in the low-speed mode, the switch S4 is closed in the peripheral unit 2 and as a result the data line D− is pulled to the supply potential Vbus via the pull-up resistor Rpu. In the host system 1, the data line D+ is permanently connected to the ground potential GND via the pull-down resistor Rpd and the closed switch S2. A current cannot flow in this case, since the data line D+ is not connected to the supply potential Vbus via the pull-up resistor Rpu as a result of the switch S3 being open.

If a peripheral unit 2 is not connected to the host system 1, the data line D− is put at a defined potential, namely the ground potential GND, via the series circuit comprising the pull-down resistor Rpd and the resistor Rw when the switch S1 is open. The comparatively high resistance of Rw means that only a very small current flows again.

To detect whether a peripheral unit 2 is connected, the switch S1 is closed, so that if a peripheral unit 2 is connected a current flows from the supply potential Vbus to ground GND via the pull-up resistor Rpu, the switch S4, the data line D− and the pull-down resistor Rpd. The resultant level changes on the data line D− are detected and evaluated in the host system 1.

The exemplary embodiment shown in FIG. 7 can be used in three different modes of operation. In a first mode of operation, the switches S1 and S2 are always open, and it is thus not possible to identify whether a peripheral unit 2 is connected to the host system 1. However, it is advantageous that a bias current does not flow, and hence the current required is reduced. This mode of operation is of particular interest for applications which do not require any detection of when a peripheral unit 2 is connected or removed, such as a USB-based SIM card in a mobile phone, for example.

In a second mode of operation, depending on the data transmission rate chosen, the switches S1 and S2 are closed only when it is necessary to check whether a peripheral unit 2 is connected to the host 1. This check can be performed periodically or else at times at which a peripheral unit 2 is expected to be connected to or disconnected from the host 1. If the switch S1 or S2 is open, a very small current, or no current in instances of application in which the resistors Rw can be omitted completely, flows via the pull-down resistors Rpd. If the switch S1 or S2 is closed, it is possible to detect when a peripheral unit 2 is connected to a host 1.

In a third mode, the switches S1 and S2 are always closed. In this way, compatibility with conventional USB systems is obtained with suitable values for the pull-down resistors Rpd and the pull-up resistors Rpu. The connection of a peripheral unit 2 to a host 1 can be detected at any time, but for this a bias current will flow constantly, exactly as in the case of the USB bus standard.

What is claimed is:

1. An apparatus for detecting a connection of a peripheral unit to a host system via a data transmission interface, wherein the host system comprises at least one switching device which sets a connection between at least one data line of the data transmission interface and a prescribed potential in the host system.

2. The apparatus as claimed in claim 1, wherein the switching device comprises a series circuit having a first resistor connected in series with a switch.

3. The apparatus as claimed in claim 2, wherein the switching device further comprises a second resistor connected electrically in parallel with the series circuit.

4. The apparatus as claimed in claim 2, wherein the switching device further comprises a second resistor connected electrically in parallel with the switch.

5. The apparatus as claimed in claim 1, wherein the prescribed potential in the host system is the ground potential.

6. The apparatus as claimed in claim 5, wherein the apparatus is configured for a high-speed data mode such that the data transmission interface has first and second data lines, the first data line is connected to a supply potential via a pull-up resistor, the second data line is connected to the ground potential via a pull-down resistor, and the first data line is connected to the ground potential via the switching device.

7. The apparatus as claimed in claim 5, wherein the apparatus is configured for a low-speed data mode such that the data transmission interface has first and second data lines, the second data line is connected to a supply potential via a pull-up resistor, the first data line D+ is connected to the ground potential directly via a pull-down resistor, and the second data line is connected to the ground potential via the switching device.

8. The apparatus as claimed in claim 1, wherein the switching device is connected to a cycle generator.

9. The apparatus as claimed in claim 1, wherein the data transmission interface has two data lines, a voltage supply line, and a ground line.

10. The apparatus as claimed in claim 9, wherein the data lines are connected to the ground line in the host system via switching devices, and to the voltage supply line in the peripheral unit via further switching devices and via at least one resistor.

11. The apparatus as claimed in claim 10, wherein the data transmission interface corresponds to the universal serial bus USB 2.0 specification when the connections of the switching devices in the host system are connected.

12. A method for detecting a connection of a peripheral unit to a host system via a data transmission interface, comprising the step of selectively connecting at least one data line of the data transmission interface in the host system to a first prescribed potential.

13. The method as claimed in claim 12, further comprising the step of periodically connecting the at least one data line of the data transmission interface to the first prescribed potential.

14. The method as claimed in claim 12, further comprising the step of taking a data transmission rate stipulated in the peripheral unit as a basis for selectively connecting the at least one data line of the data transmission interface to the first prescribed potential.

15. The method as claimed in claim 14, further comprising the steps of, in a mode for high data transmission rates, selectively connecting the first data line to a second prescribed potential, and permanently connecting the second data line to the first prescribed potential via a resistor.

16. The method as claimed in claim 14, further comprising the steps of, in a mode for low data transmission rates, selectively connecting the second data line to the first prescribed potential, and permanently connecting the first data line to the second prescribed potential via a resistor.

17. The method as claimed in claim 12, further comprising the step of achieving compatibility with the universal serial bus standard USB 2.0 by permanently connecting data lines of the data transmission interface to the first prescribed potential in the host system via resistors.

18. An apparatus for detecting a connection of a peripheral unit to a host system via a data transmission interface, wherein the host system comprises a switching means for setting a connection between at least one data line of the data transmission interface and a prescribed potential in the host system.

19. The apparatus as claimed in claim 18, wherein the switching means is connected to a cycle generating means.
